(19) United States
(12) Patent Application Publication
(10) Pub. No.: US 2005/0159963 A1
(43) Pub. Date: Jul. 21, 2005

(54) Attorney closing and title services

(76) Inventor: David A. Gotschall, Houston, TX (US)

Correspondence Address: Edward P. Black, P.O. Box 11690, Klein, TX, 77391, US

(21) Appl. No.: 10/364,110

(22) Filed: Feb. 10, 2003

(51) Int. Cl. G06F 17/60

(52) U.S. Cl. 705/1

(57) ABSTRACT

This invention provides a method for non-professional real estate personnel to follow the correct procedures and either prepare the correct documentation or order the correct documentation form legal sources in order to be completely prepared to conduct a real estate transfer under a comprehensive range of possible real estate transactions. The method provides a flow chart for the user to follow, which, when used correctly reduces the complex nature of deciding which documents and procedures might be necessary to a simple process of asking questions, branching through the chart on the basis of the answers to those questions and recording the tasks encountered. After completing the flow chart, the user has a recorded list of required actions and documents which will represent the complete description of the subject transfer.

### I. BACKGROUND OF THE INVENTION

Transactions of all types, affecting both real estate and substantial non-real assets, have historically been conducted under the supervision of and at the office of an attorney representing one of the participants. Since early in the 20^{th} century, title companies have become common. Title companies began as a service to real-estate attorneys by providing the non-legal services needed to effect the legal transfer of real property. They began as a simple service providing searches on the “chain of title” for real property. Later, an indemnity aspect was added and they began offering insurance against flaws in title when the title was researched by their personnel.

Eventually, the actual title transfer (closing) was moved to the offices of the title company from the attorney's offices. In recent years, specialists (i.e., closing attorneys, escrow companies and title companies) have become more common, their use being settled by the recommendation or requirements of real estate agents, lenders, or attorneys for the parties.

Closing services, title services and escrow services have evolved as business adjuncts to most purchase/sale, loan or and other transactions involving substantial assets. They provide three out of the four essential services necessary in such transactions. These three functions, while each requiring a certain amount of specialized trained personnel, records, non-legal forms, business location and equipment, and banking and accounting capability, are entirely lay functions, i.e., not requiring the use of a lawyer or law office. The fourth essential service, document preparation to properly effectuate the transaction, is a quintessential service of the legal profession.

Escrow service, which is the act of receiving and holding other people's funds, along with their instructions for the conditions and timing of disbursement of the funds, is not uncommon in non-real estate matters. Escrow service has a recurring role in the purchase and sale, and/or third party lending on real estate, of handling earnest money and purchase money funds deposited by the buyer prior to a sale transaction, and handling loan proceeds forwarded by a lender prior to loan disbursement. The size of the transaction, relationship of the parties, and requirements of a lender most often dictate whether these services will be utilized. Escrow services have traditionally been provided by accountants or attorneys, or by their trained staff members, or by escrow service firms organized and providing trained staff for that purpose, and, in recent years, title company offices set up to provide such services.

Escrow Functions
Deposit Earnest Money for closings
Deposit Loan proceeds for closings
Deposit Buyer cash at closing for closings
Disburse closing checks
Retain funds and disburse according to written disbursement agreement authorized by Title Insurance Underwriter and/or agent

Closing service, or settlement service, may be defined as providing a formal venue and time, neutral trained personnel, and non-legal paperwork (e.g. closing statements), in order for parties to a transaction to personally attend, consummate, and legally effectuate a transaction. As is the case with escrow service, closing service is frequently utilized in non-real estate transactions. Also, it is very commonly requested for real estate purchase and sale transactions and loan transactions, depending upon the transaction size, affinity of the Buyer and Seller, requirements of any lender, and requirement of any title guarantor or insurer. In the past, closing services have been provided by: a.) one of the attorneys for the parties or their trained staff, b.) neutral closing attorneys or staff, c.) escrow service companies, and d.) title company offices set up to provide closing service as well as escrow.:

Closing Service Functions:
Coordinate ordering of any required title and/or tax search
Order existing loan payoff information
Order survey
Order LEGAL document preparation, for Deed, Seller Finance, Third Party Lender, etc, if required
Order proof of insurance, if required
Order closing papers, if required
Prepare drafts of settlement statement
Obtain Realtor(s), loan broker, lender approval to draft settlement statement
Distribute final settlement statement to participants, agent(s), loan broker, lender
Conduct closing
Deposit funds into escrow account
Disburse funds after obtaining all necessary disbursement approvals
Record legal documents
Copy documents for participants and lender
Process file for title policy(s) to be issued

Title service might be simply defined obtaining as a search or examination, by a qualified party with credentials approved by the participants, title to an asset in order to determine identity of the legal owner(s) of the asset. A title search identifies the freedom from or status of any existing legal claims on the asset, to the satisfaction of the owner(s), buyer, lender or other interested party. While obviously advisable for transactions of any substantial asset, (real estate or non-real estate) the prior approval of a title search is commonly deemed a necessity by a prospective Buyer or Lender on real estate, or for loaning money to be secured by real estate. Types of title related searches:
1. An Insured title search denotes a special pre-closing search defining the form and requirements for the real estate closing such that the title insurer will indemnify the Buyer and/or Lender against subsequent title loss under the terms of the title policy.
2. A non-insured title search varies with locale as to form and quality. Real estate practitioners, as a matter of caution, never explicitly recommend them.
3. A UCC or like search is a search of the non-real estate official records of liens or mortgages on non-real estate (chattels).
4. A tax search is a search of the official taxing authority(s) for any ad valorem or other taxes that might constitute a lien or claim on the property, and is normally ordered in conjunction with all insured searches.

Title Service Functions:
Order non-insured search,
Order insured search (title policy)
Order other document as directed
Transmit title search to parties,
Review search
Instruct client to consult their attorney to cure title problems
Order tax search, if requested on non-insured or no search file
Transmit tax search to parties
Review tax search, with instructions to consult their attorney to cure any problems

Legal Services. The fourth and final normal function necessary for most transactions, both real estate and non-real estate, is, of course, document preparation necessary to legally effectuate the transaction. While most states allow the parties themselves to prepare their own legal documents, it is the task of the staff of the closing, title and escrow service to recognize when and if legal document preparation (“LEGAL docprep”) or legal advice (“LEGAL advice”) should be ordered. This is usually stated as a condition for the proposed transaction participant(s) to order. Most states recognize the following listed activities as legal service, reserved for licensed attorneys.

Legal Service Functions:
Help on Purchase-Sales Contracts (Earnest Money Contracts)
Assist with formation of legal obligation to buy/sell
Explain terms
Cure Title Problems
Release and Negotiate Liens
Conduct Irregular transfers
Record irregularities
Advise on and/or Conduct Adverse Possession
Deal with Contract default
Resolve Probate/heirship issues
Resolve Tax issues
Preparation of conveyance documents
Determine Entity status
Prepare financing documentation note
Check Mortgage or Deed of Trust

Title companies have come to prefer to do only those title projects which involve the sale or refinance of single family housing units having a third-party (corporate) lender. This kind of title work is by far the most common, and includes a title insurance policy. However, there are numerous other kinds of transfers that are possible. For example:
Property ownership is regularly transferred as inheritance on the death of a property owner.
In community property states, divorce creates a necessary division of community property including real property.
Real estate is sometimes given as a gift to family members.
Occasionally, there is a legal action, sometimes called “Trespass to Try Title”, which asks a court to vest ownership in real estate to some litigant.

All of these transfers do not include title insurance, and are therefore not part of the “standard” title company offerings, but they all require preparation of documents and some version of transfer or closing ceremony. Lacking a title company office to effect such a service, the property owners must engage the (often expensive) services of an attorney. Much of this work is non-legal in nature and therefore doesn't require an attorney but cannot easily be done in any other fashion.

No quick, efficient, cost effective means presently exists to assist a participant in such a non-standard transaction in determining precisely what services, personnel, location and nature of professional assistance and cost may normally be required or advisable for the transaction at hand. People needing such non-standard help only have a few places to turn:
Attorneys. It is difficult to locate attorneys who may specialize in asset transactions. It is even more difficult to find one willing to one willing to settle for a modest fee.
Real Estate Agents. Agents are trained only to list and sell real estate and most of their expertise and energy is geared toward that end.
Loan Officers. Loan officers are focused only on the mechanisms and procedures of closing loans. They assiduously avoid stepping outside that expertise.
Escrow Companies and Title Companies. Trained to handle real estate purchase-sales and loans requiring a title policy or insured closings, and most of their expertise and energies are directed toward those transactions only.

### II. BRIEF SUMMARY OF THE INVENTION

This is a method of doing business invention. The inventor has developed a novel method to
(a) define the components of “standard” and “non-standard” transactions in a way designed to allow a participant in a proposed transaction to make a knowledgeable choice as to the services and personnel he or she may require;
(b) systematize the components of “standard” and “non-standard” closing, title and escrow services so that they may be reduced to a menu-driven selection of guidelines for processing the transaction along with the necessary non-legal forms with preparation instructions and, when called for, referral to attorneys.
   This concept is amenable to modularization, in that each standard or non-standard transfer may have its associated forms and instructions prepared in kit form for delivery to an employee of the escrow closing and title service, escrow company, title company, or closing attorney for completion. Of course, those documents requiring an attorney must be prepared either directly, or under the direct supervision of a licensed attorney.

The figures, as flow charts, lay out the details of the invention.

### III. BRIEF DESCRIPTION OF THE SEVERAL VIEWS OF THE DRAWING

The following pages present a flow chart showing all the possible services enabled by the invention. Note that while the charts are in the form of a software flow-chart, the purpose is to lead the user to draw the proper conclusion regarding the nature of the work required by each situation. It is not intended as an algorithmic method nor even to be amenable to programming into a computer. The flow chart is the invention. It makes possible a simple method for determining exactly what services to provide in each situation calling for real estate service. The flow charts are used in preparing single instruction sheets for each variation of property transfer or title service required. They are as follows:

FIG. 1. Initial decision tree in determining services to be rendered, including decision tree for purchase/sale realty transfers or refinances.

FIG. 2. First page of Decision tree for non-purchase transfers requiring closing services.

FIG. 3. Second page of Decision tree for non-purchase transfers requiring closing services.

FIG. 4. First Page of Decision tree for non-purchase transfers requiring neither closing services nor a title search.

FIG. 5. Second Page of Decision tree for non-purchase transfers requiring neither closing services nor a title search.

FIG. 6. First Page of Decision tree for non-purchase transfers not requiring closing services but requiring a title search.

FIG. 7. Second Page of Decision tree for non-purchase transfers not requiring closing services but requiring a title search.

FIG. 8. Third Page of Decision tree for non-purchase transfers not requiring closing services but requiring a title search.

FIG. 9. Fourth Page of Decision tree for non-purchase transfers not requiring closing services but requiring a title search.

FIG. 10. Fifth Page of Decision tree for non-purchase transfers not requiring closing services but requiring a title search.

FIG. 11. Sixth Page of Decision tree for non-purchase transfers not requiring closing services but requiring a title search.

FIG. 12. Decision tree for LDP Subroutine.

FIG. 13. Decision tree for EMC Subroutine.

FIG. 14. Decision tree for Guardianship Subroutine.

FIG. 15. Decision tree for NI Subroutine.

FIG. 16. Decision tree for Title Subroutine.

FIG. 17. Decision tree for Entity Subroutine.

FIG. 18. Decision tree for Probate Subroutine.

### IV. DRAWINGS

See included sheets.

### Index of Abbreviations and/or Terminology Use in Drawings

1. BOD Board of Directors
2. Closing The furnishing of closing statement, notorial and recordation service at in-person instrument execution ceremony for seller/buyer/broker who are present on exchange
3. Conduct insured closing Final disbursement, recordation, title policy issuance
4. Consideration Seller/buyer receiving/giving value for transfer of real estate rights
5. Deed Legal document transferring full real estate interest, prepared by an attorney.
6. DEP Deposit
7. DOC Legal documentation
8. EM Earnest money, often deposited into an escrow account by an escrow service provider
9. EMC Earnest money contract (purchase/sale agreement)
10. Executed Signed and notarized legal instruments in deed or mortgage
11. Insured closing closing for which owner and/or mortgagee title policies are to be issued
12. KD Contract for deed
13. KD or K/D Contract for Deed, an executory contract, transferring present possessory real estate rights with seller assuming legal obligation to transfer deed at later date
14. KD Sale Delivery of contract for deed from seller to buyer for present non-exchange consideration
15. L/O Lease Option
16. L/P Lease Purchase
17. LDP Legal documentation Preparation
18. LEGAL Legal preparation
19. LEGAL APT Legal appointment
20. NI or N/I Non-insured
21. PI Private Investigator
22. PoD Proof of Divestiture
23. PREP Prepare
24. PROP Property
25. REC Recommend
26. REQ Required/Requirement
27. RLA Require Legal Appointment
28. RLDP Require Legal Document Preparation
29. RPI Real Property Interest
30. RPR Real property rights
31. Sale Delivery of deed from seller to buyer for consideration
32. SCHED Schedule
33. Set closing Pencil date on closing calendar suitable to seller/buyer/borrower, Order appropriate title search—if any, order prep legal docs, order prep closing statement, order loan payoff/assumption stmts, order survey if req
34. STMT Statement
35. T/I Title Insurance
36. TPL Third party lender sale

The following constitutes a comprehensive list of all the activities called for in the Figures:

Closing Activities

Insured Closing
Business Sale Closing
Courtesy Closing
Insured Closing at outside office
Lease Closing
Note Modification Closing
Payoff
K/D Closing
L/O or L/P Closing
   Scheduling Activities:
LEGAL Doc.Prep. Business Sale
LEGAL Doc Prep. Lease
LEGAL Docprep re: L/O or L/P Closing
LEGAL Deed.Prep.
LEGAL Doc.Prep. re: K/D Closing
LEGAL Doc.Prep. for Note Modification Closing
LEGAL Doc.Prep. for Payoff
LEGAL Advice
LEGAL Doc.Prep. Contract For Deed
LEGAL Doc.Prep. Deed
LEGAL Advice re: Probate
LEGAL Advice re: Deed Prep. per Trustee requirement
LEGAL Deed Prep. Per Business Dissolution
LEGAL Deed Prep per Lender or Title Co. Instructions
LEGAL Doc.Prep. 2^{nd} Lien
LEGAL Advice re: Guardianship
LEGAL Advice re: Suit to Quiet Title
LEGAL Advice re; Doc.Prep. Gift Deed
LEGAL DocPrep Gift Deed
LEGAL Advice re: Will Probating
LEGAL Doc.Prep. EMC
LEGAL Advice Buyer/Seller EMC
LEGAL Advice re: Mortgage Foreclosure or K/D Forfeiture
LEGAL Doc.Prep re; EMC Busniess Purchase/Sale
LEGAL Advice re: Business Purchase/Sale
LEGAL Advice re: Abstract of Judgment Payoff/Negotiation
LEGAL Acvice re: Lien Payoff/Negotiation
LEGAL Doc.Prep. Business Sale
LEGAL ADVICE re: Wills
LEGAL Doc.Prep. re: Wills
LEGAL Advice re: Will Modification
LEGAL Doc.Prep re: Will Modification
LEGAL Advice re: Adverse Possession
WILL/TRUST Advice w/ CPA or Tax Attorney
   Ordering Searches/Activities
   Order a Non-insured Close
   Order an insured title search
   Order an insured TAX serach
   Order LEGAL Doc.Prep. Lease Purchase/Option
   Order Listing of Documents in file order
   Order LEGAL P.I. Search
   Order non-insured TAX Search
   Order LEGAL Doc.Prep. Seller Finance
   Order Partnership Agreement
   Order Trust Agreement
      Conducting Activities
   Conduct Non-insured Close (Note: Any Conducting of a Closing requires a duly trained, licensed, if applicable, Closer and/or Escrow Officer and/or Notary Public)
   Conduct Insured Closing
   Conduct Bus Sale Closing
   Conduct Lease Closing
   Conduct L/O, L/P Closing
   Conduct K/D Closing
   Conduct Note Mod. Closing
   Conduct Payoff
   Conduct Courtesy Close
   Conduct Insured Close at Outside Office
   Conduct LEGAL Advice incident to Probate Proceedings (Note: Any Conducting of LEGAL requires a duly qualified, licensed Attorney)
   Conduct LEGAL Advice re: Suit to Quiet Title
   Conduct LEGAL Representation re: Suit to Quiet Title (Note: Any LEGAL Representaion requires a duly qualified, licensed Attorney)
   Conduct LEGAL Doc.Prep Gift Deed
   Conduct LEGAL Advice re: Will Preparation
   Conduct LEGAL EMC Prep. (Note: Any LEGAL Document Preparation requires a duly qualified, licensed Attorney
   Conduct LEGAL Buyer/Seller Rep.
   Conduct LEGAL Buyer/Seller Rep. Mortgage Foreclosure or Kdeed Forfeiture
   Conduct LEGAL EMC Prep Business Purchase/Sale
   Conduct LEGAL Advice/Negotiation re: Abstract of Judgment Payoff, Lien Payoff
   Conduct Will/Trust LEGAL Advice/ACCOUNTING Advice (Note: Any Accounting Advice must be given by a duly qualified Tax Attorney or C.P.A.
   Conduct LEGAL Advice re: Will Doc.Prep.
      Delivering Activities
   Deliver Insured Ttitle and TAX Searches (To parties who ordered them)
   Deliver LEGAL EMC Preparation
   Deliver P'Ship Agreement
   Deliver Trust Agreement
      Obtaining Activities
   Obtain guardianhip order (Obtain implies a LEGAL action by a duly qualified, licensed Attorney
   Obtain approval of court-ordered Guardian
   Obtain opinion on Capacity

### V. DESCRIPTION OF THE PREFERRED EMBODIMENT

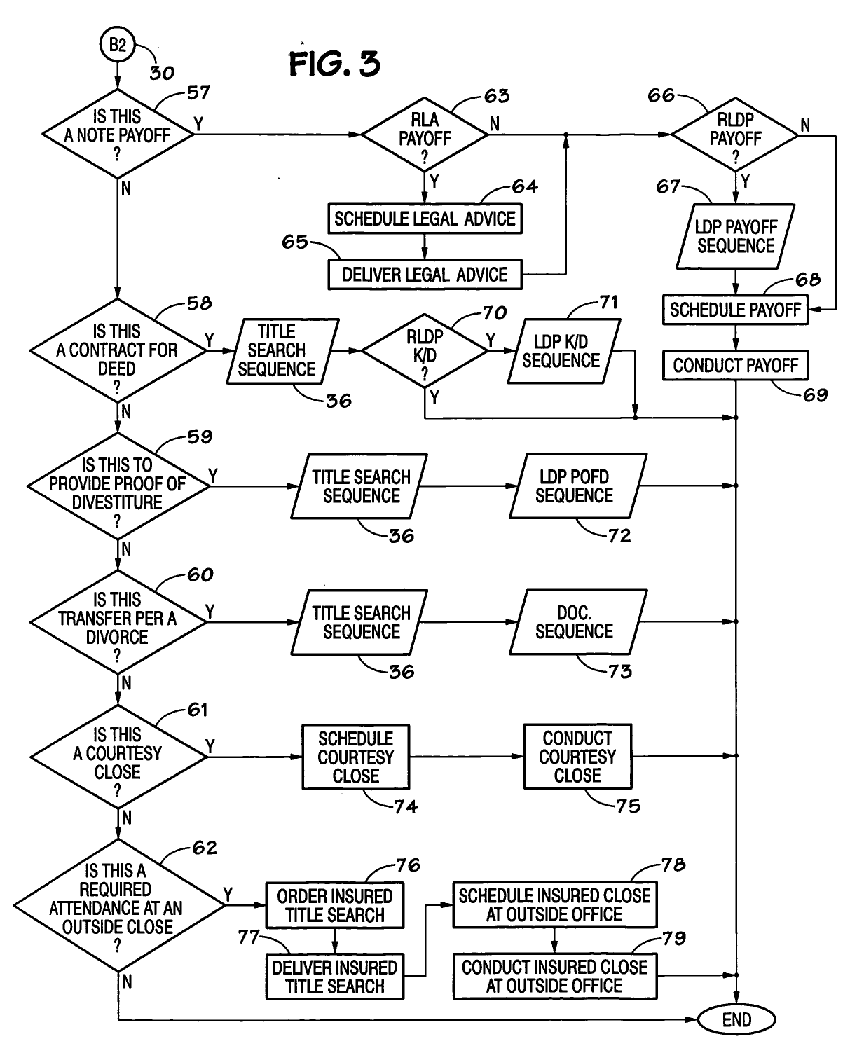

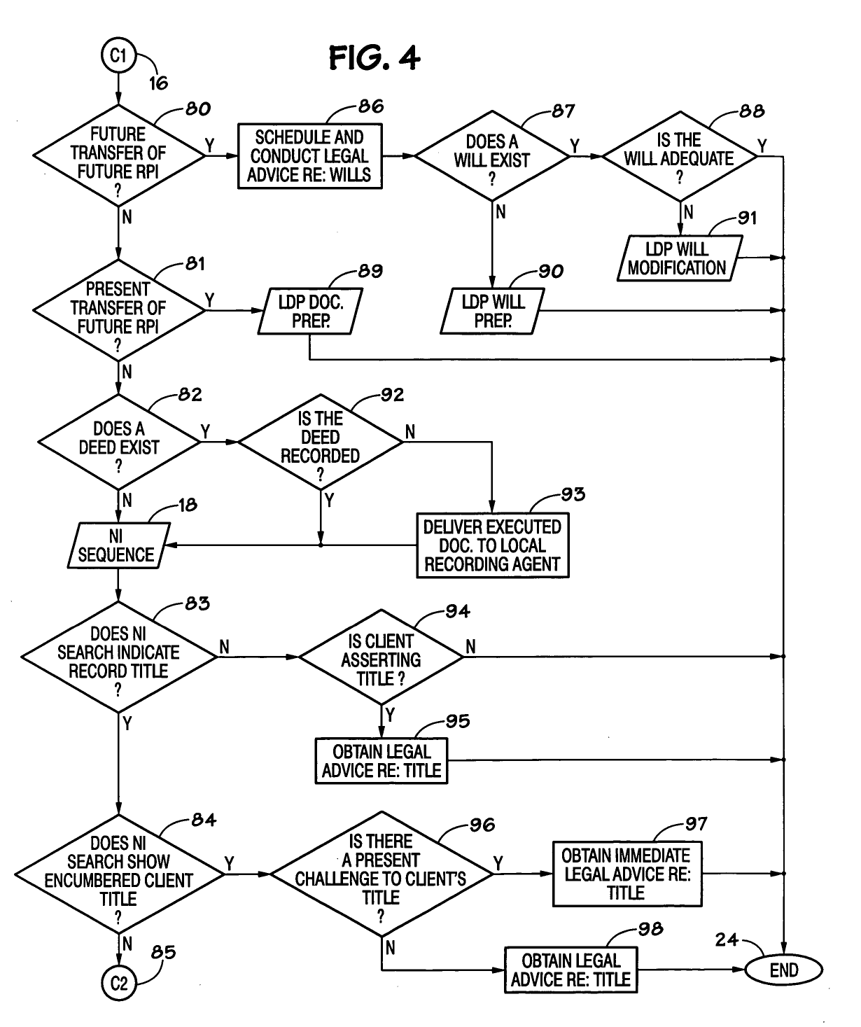

To use the invention, it must be understood that the “flow charts” of the drawings make use of geometric figures which each have a special meaning:
1. Ovals represent the start or end of a use of the chart, which, is clearly labelled.
2. Diamonds are branch points where the user must ask a question and follow one of two different paths out of the diamond, depending on whether the answer to the question is yes or no.
3. Rectangles represent a task that must be completed.
4. Trapezoids represent subroutines which are each laid out in FIG. 5.
5. Circles signal the transfer into or out of any single page of the figures, for example the circle C1 (15) directs the user to FIG. 3A.
6. Lines show the sequence of use of the figures with the direction of travel being indicated by the arrowheads on one end of the lines.

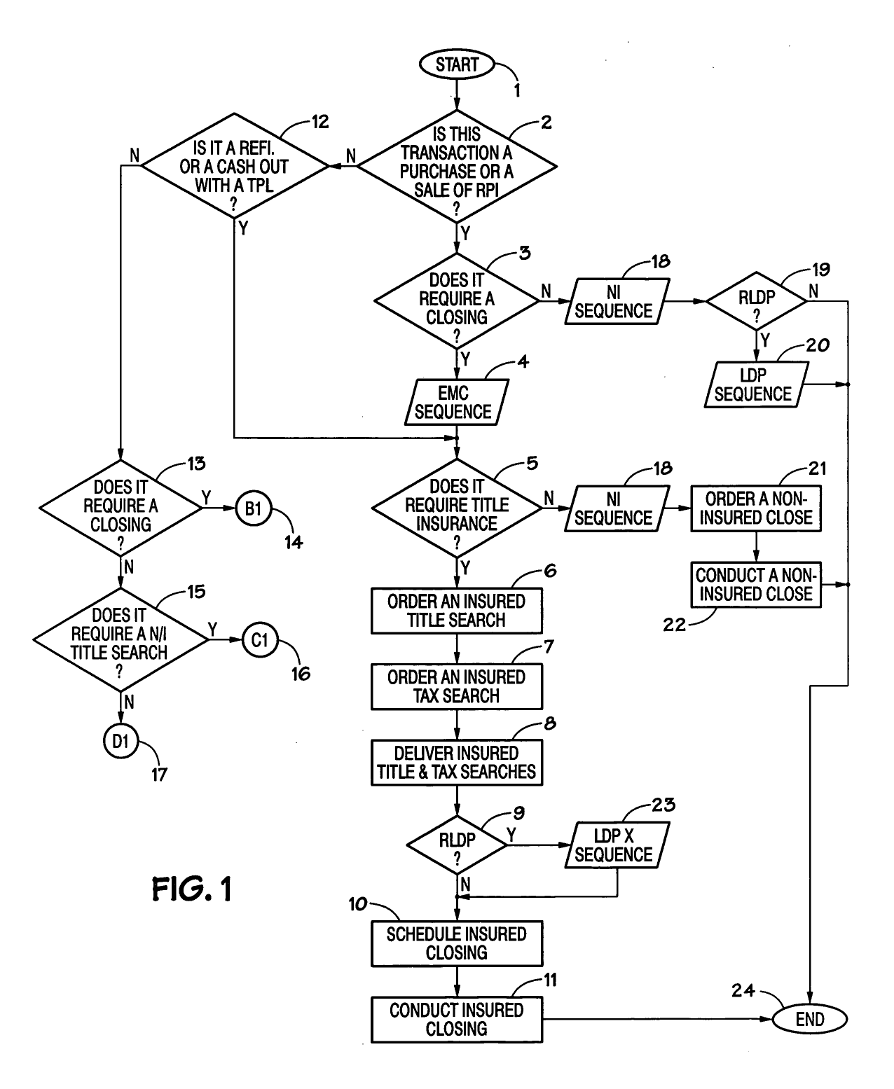

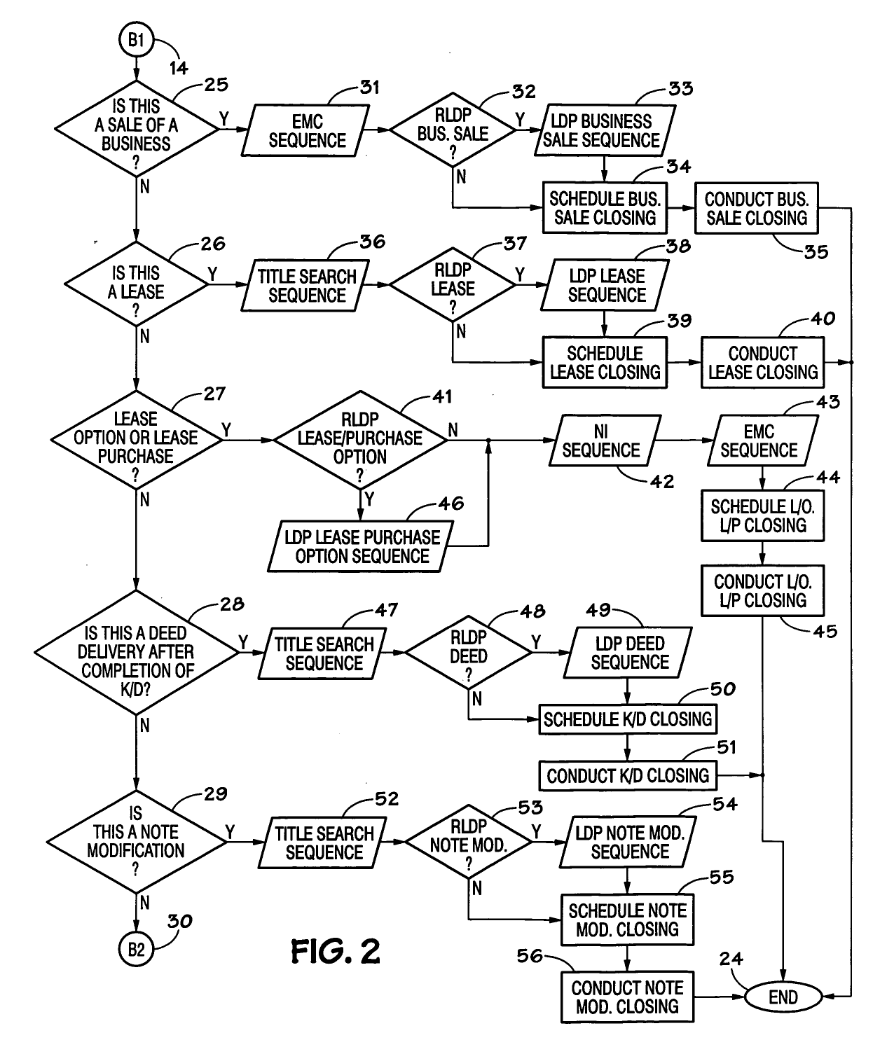

Looking at FIG. 1, A user of the invention would start at the START oval (1). The following sequence of events leads to the most common transaction, which is the closing of a real property transfer with title insurance: The first branch is the positive (yes) route out of the first diamond (2). Since, in the example there will be a closing, one follows the yes branch out of diamond (3). One is next lead to the EM Sequence (4), which is detailed in FIG. 5. Next, since there will be title insurance, one follows the yes branch from diamond (5), where one orders an insured title search (6), orders an insured tax search (7) and delivers both searches (8). Many title company transactions require preparation of legal documents, to do so one takes the yes branch out of diamond (9) to the scheduling and conducting of required Legal document preparation (23). Finally, one sets an insured closing (10), and conducts the insured closing (11), before finishing (24).

In the path illustrated, there were a total of 6 distinct actions taken, shown by numbers 6, 7, 8, 10, 11 & 23. The invention provides a path to a fixed set of actions for each permutation of situations to be faced by a user of the invention. The tasks to be done for each different permutation are the sum of the rectangles encountered in the decision tree of the invention. Each question has a path to follow to lead to the rectangles representing the actions required for the problem.

For a user to even get to C1 (16), which leads to the decision tree illustrated in FIG. 3, with its accompanying set of tasks, it is necessary to first determine that the transaction is NOT a purchase or sale of real property interests (2), is NOT a refinance or cash-out transaction using a third party lender (12), does NOT require a closing (13), and does NOT require a non-insured title search (15), i.e., take the negative branch out of diamonds 2, 12, 13, & 15.

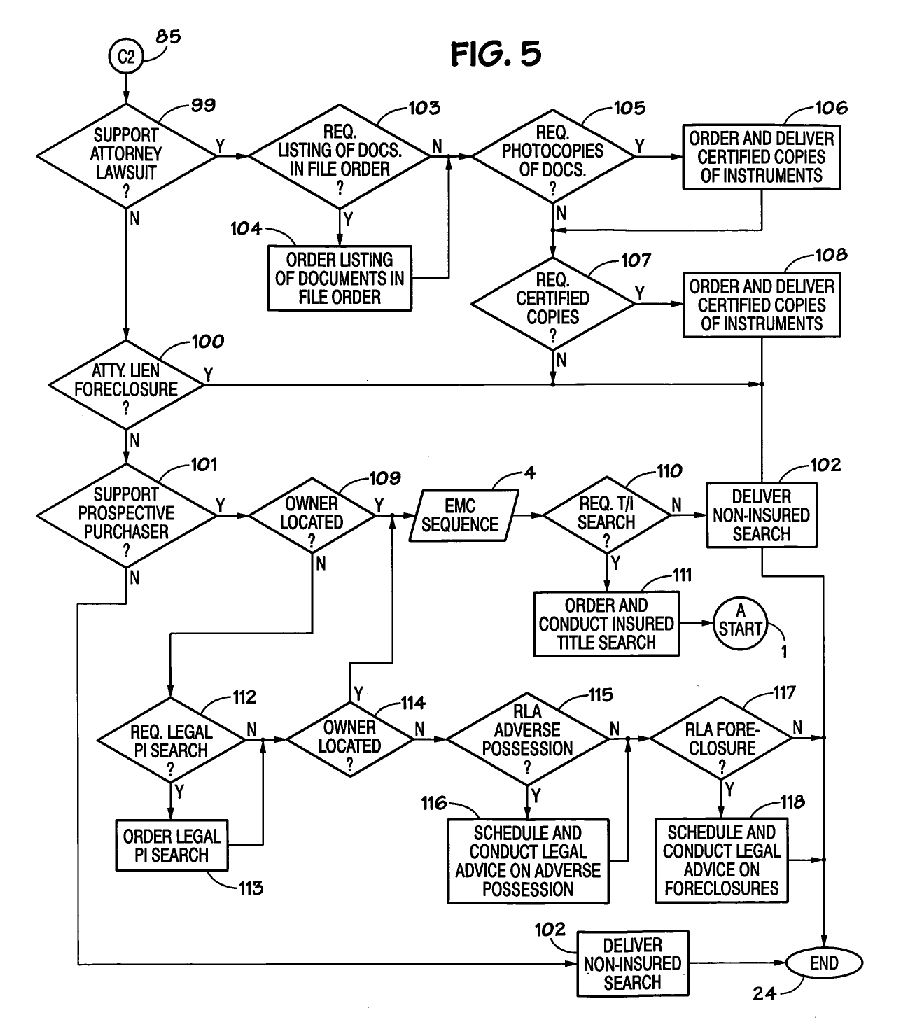

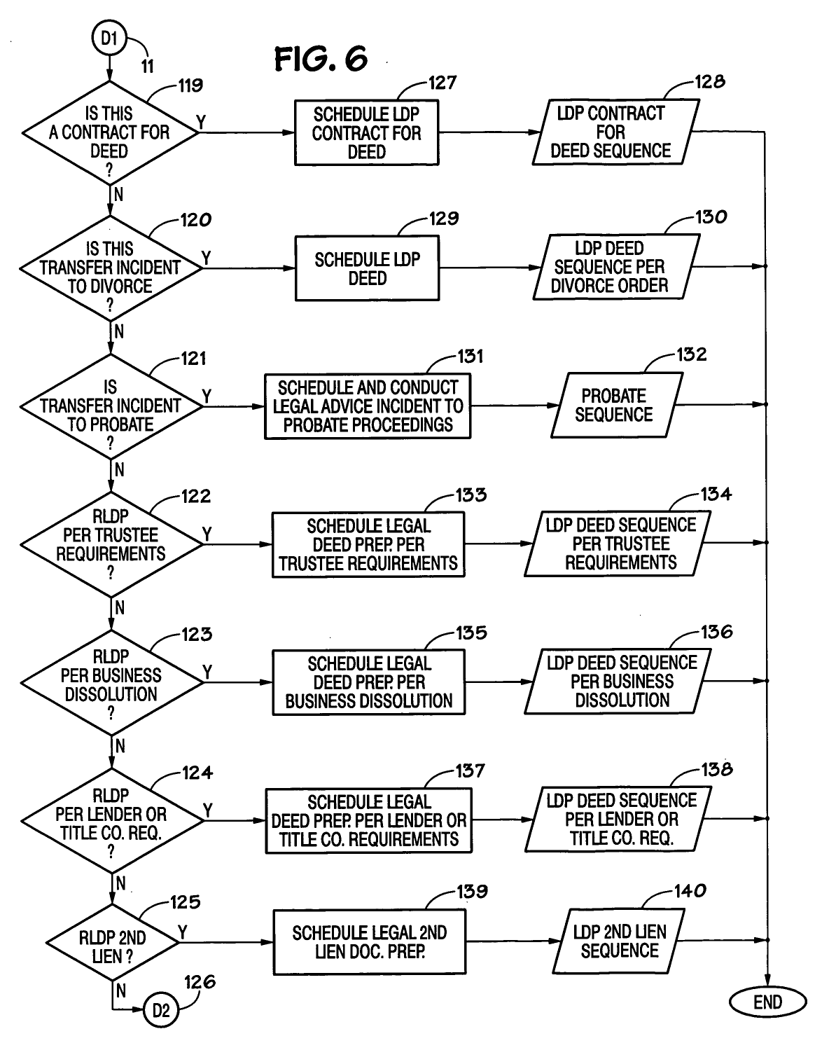

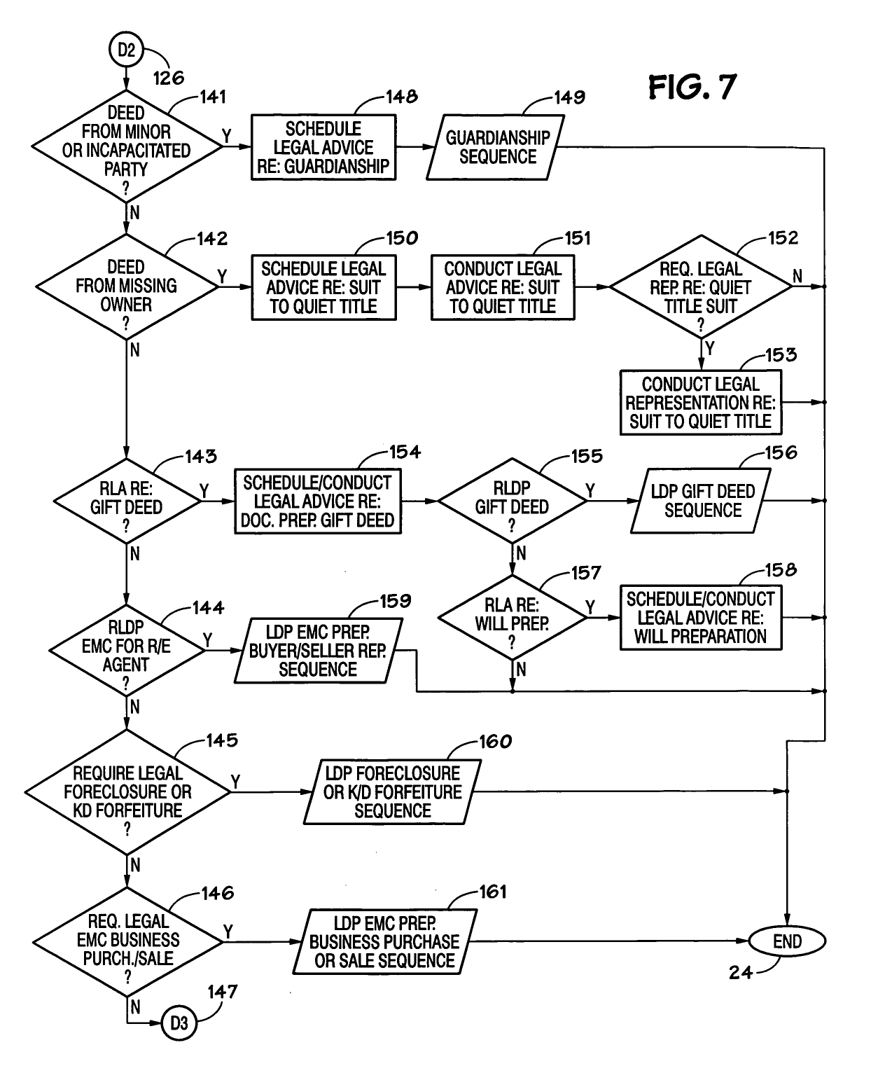

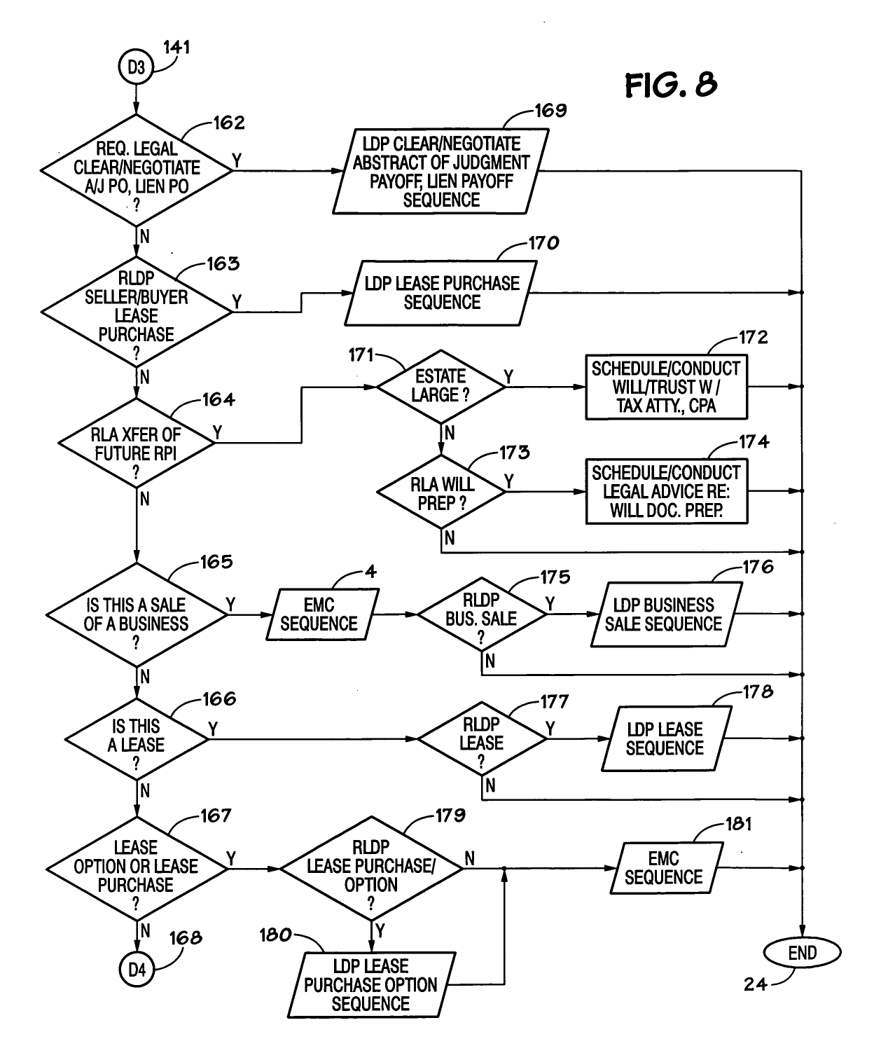

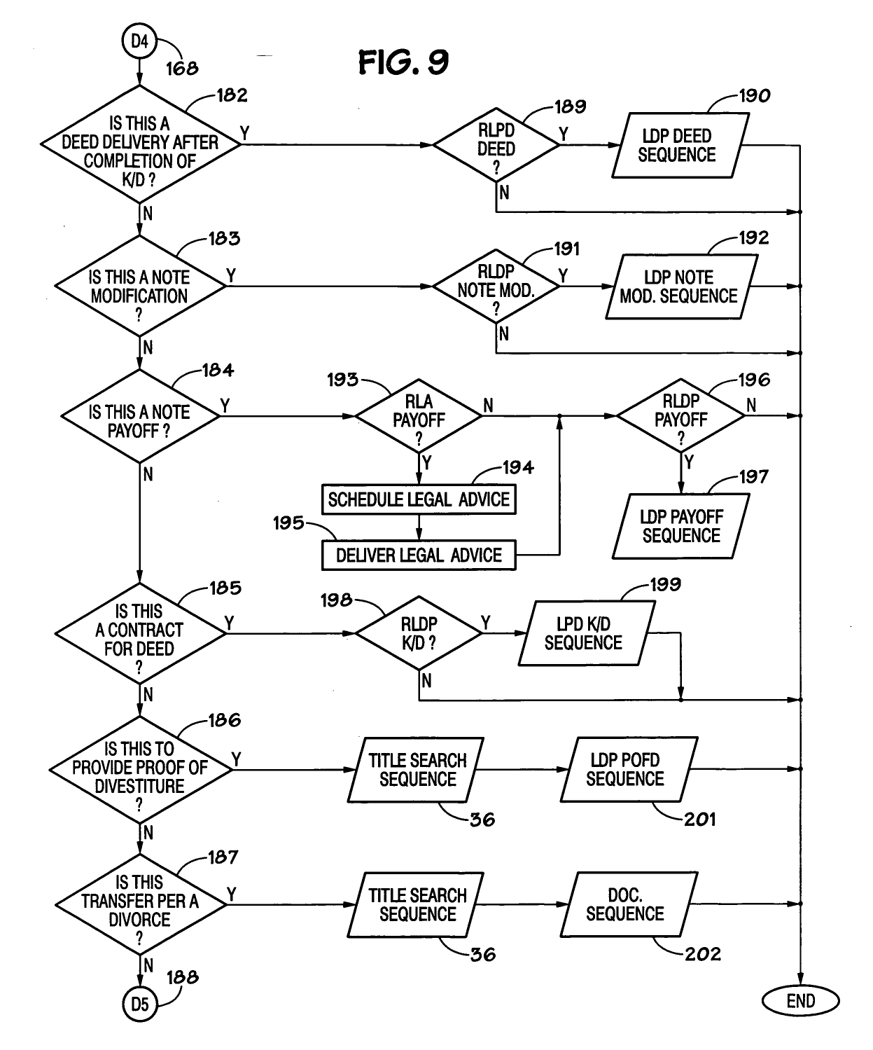

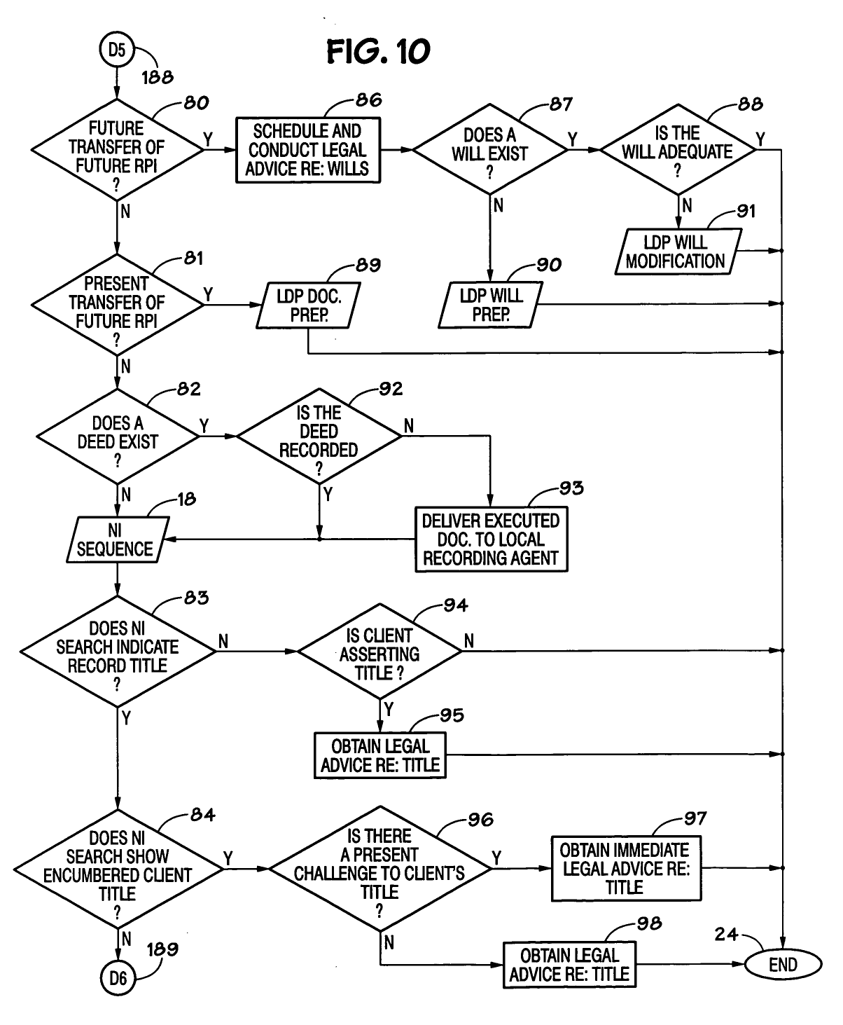

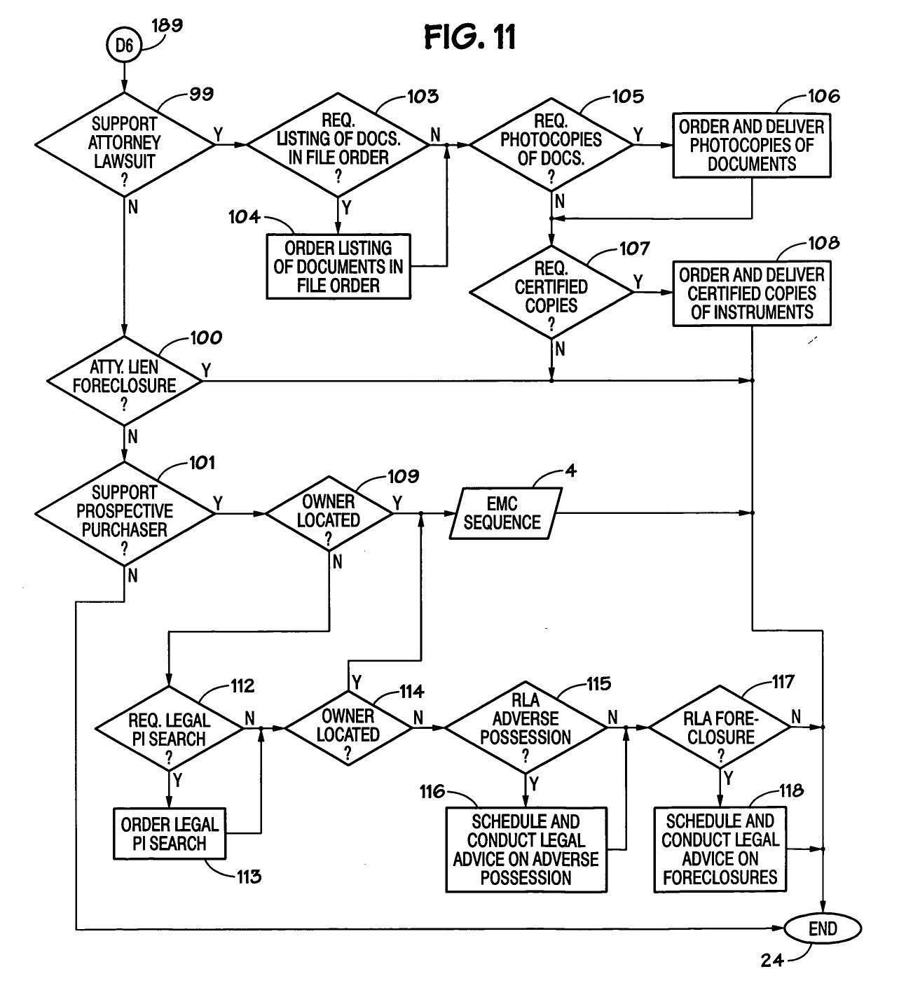

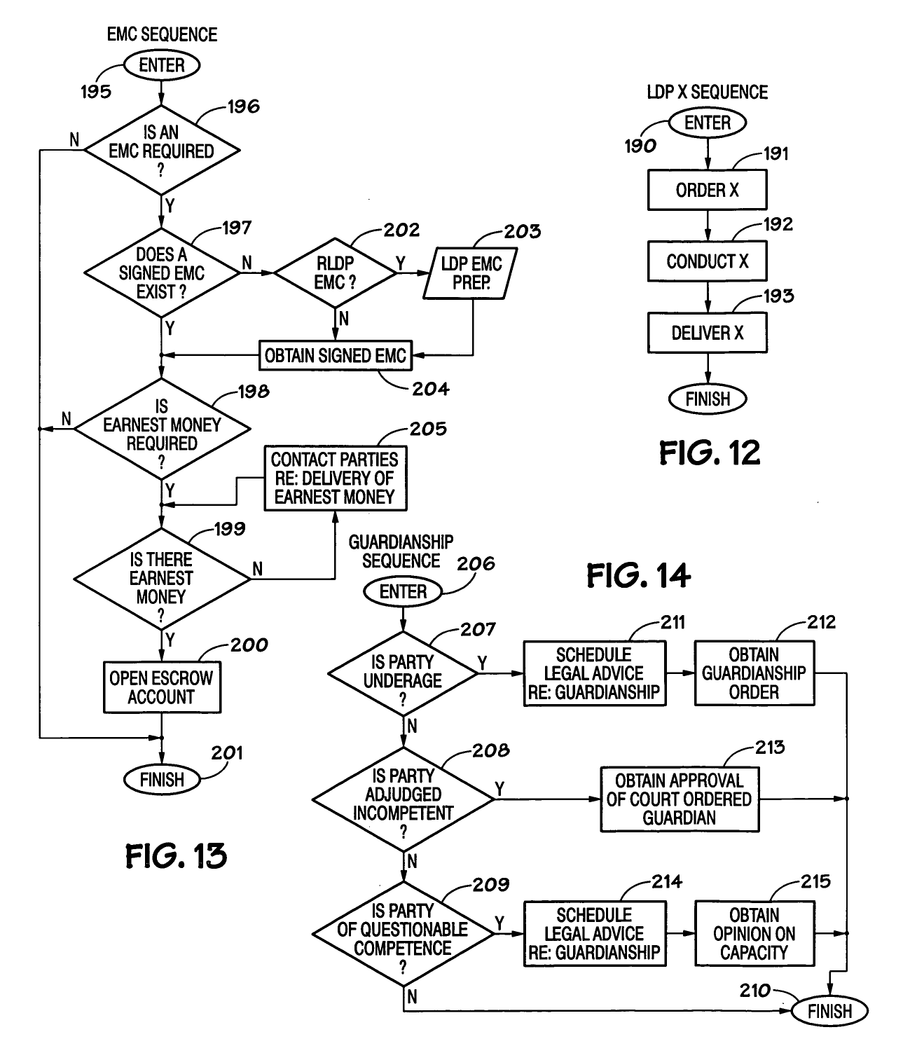

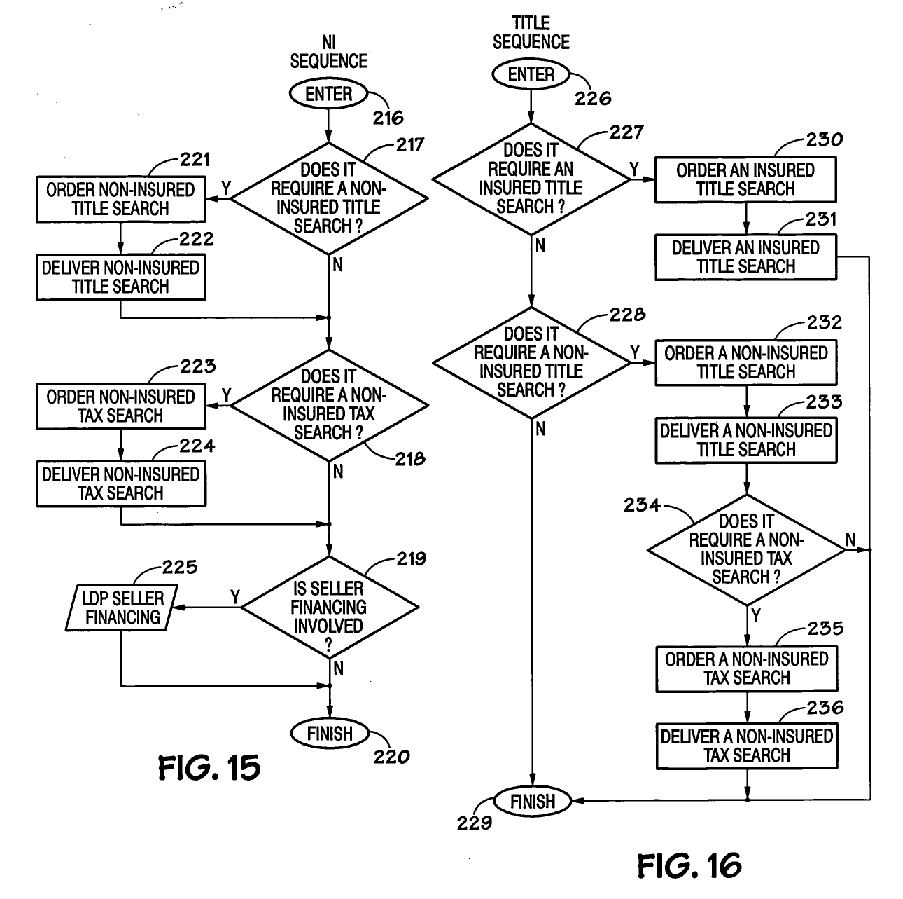

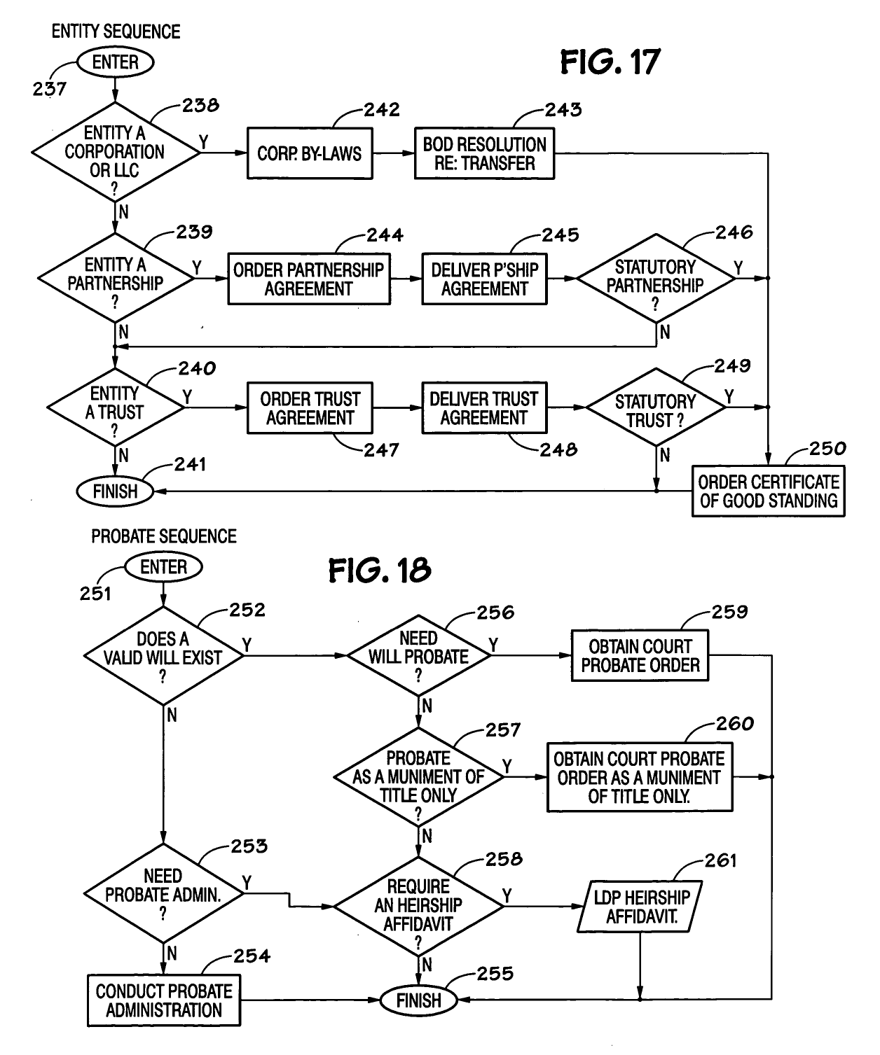

As a final example, the path to get a set of documents accompanying a transfer per divorce not requiring a Non-insured title search, one begins at FIG. 1, Start (1), and tankes the negative branch out of each of the following decision points: 2, 12, 13 & 15 to get to D1 (17). From there, one goes to FIG. 6 D1 (17) and takes the negative branch through each of the decision points numbered 119-125 to get to D2 (126). Next, on FIG. 7, D2 (126), one again takes the negative branch through each of the decision points numbered 141-146 to get to D3 (147). Continuing, one goes to FIG. 8, D3 (147) and takes the negative branch through each of the decision points numbered 162-167 to get to D4 (168). Finally, one goes to FIG. 9, D4 (168) and takes the negative branch through each of the decision points numbered 182-186, but then finds the question of interest and takes the positive decision path through decision point associated with a Transfer per divorce (187) to get to the Title Search Sequence (36). From there, one goes to FIG. 16, Title Sequence and works through the decision points, acquiring the appropriate information in each rectangle encountered (230-233, 235 & 236) to the END point of the subroutine (229). Next, returning to FIG. 9, one enters the LDP Doc. Sequence subroutine (202), which is found detailed in FIG. 12: Enter at 190, Order Docs. (191), Conduct Document preparation (192) and Deliver Docs. (193) before returning (194) to the entry point on FIG. 9 and continuing to the END (24).

Any person can thus follow the diagrams to accumulate the necessary tasks to complete for each problem. Persons familiar with real estate transactions are familiar with each task shown in the rectangles of the figures.

1. A method of making decisions about real estate transactions by means of a flow chart having a multiplicity of pages containing geometric figures, wherein
diamond shaped figures represent decision points,
rectangular figures represent actions,
trapezoidal figures represent subroutines,
circles represent entry or exit points on each page,
oval figures represent start or stop points,
paths through said chart are represented by a multiplicity of lines, each line having a direction indicator on one end only with flow through said flow chart being in the direction of said indicator.

2. A method for quickly determining required procedures and documentation for any kind of real estate transaction, comprising the following steps:
gathering data about the type of transaction,
working through the flow chart of claim 1,
comparing said data to each decision point in said flow chart,
following the branch indicated at said decision points,
recording each rectangle encountered while following said branches through said decision points,
performing each task shown by said encountered rectangles.

3. the method of claim 2, wherein said decision points are yes-no questions.

4. The method of claim 2, wherein said rectangles describe a mulitiplicity of actions comprising:
closing,
scheduling,
ordering,
conducting,
delivering,
obtaining
